(19) United States
(12) Patent Application Publication
(10) Pub. No.: US 2011/0265319 A1
(43) Pub. Date: Nov. 3, 2011

(54) System and Method for Rechargeable Power System for a Cargo Container Monitoring and Security System

(75) Inventor: Richard C. Meyers, Longboat, FL (US)

(73) Assignee: System Planning Corporation, Arlington, VA (US)

(21) Appl. No.: 13/179,498

(22) Filed: Jul. 9, 2011

Related U.S. Application Data
(62) Division of application No. 11/598,841, filed on Nov. 14, 2006.
(60) Provisional application No. 60/735,885, filed on Nov. 14, 2005.

(51) Int. Cl. H01R 43/00

(52) U.S. Cl. 29/825

(57) ABSTRACT

A system and method for an integrated rechargeable power system for a container monitoring and security system is provided. The power system is affixed to a container and comprises an integrated photovoltaic area conforming to the container construction, a battery pack module, power conditioning circuitry or recharge unit, and a power controller unit. The photovoltaic unit may be conventional photovoltaic crystalline cell array, or a photovoltaic coating with is applied to the walls, door, or roof of a container.

### CLAIM OF PRIORITY

The present application is a divisional of U.S. patent application Ser. No. 11/598,841 which claims priority to Provisional Application No. 60/735,885 filed Nov. 14, 2005.

### BACKGROUND OF THE INVENTION

1. Field of the Invention

The present invention relates generally to container security and, more particularly, to a shipping container security system, and to the power systems used for the electronics in this application.

2. Background of the Invention

In today's security conscious transportation environment, there is a strong need to cost-effectively and accurately monitor the contents of containerized shipments. This need exists both in the United States and abroad.

Despite the strong need, until recently few solutions, if any, have been able to provide the protection and accuracy needed to suit the transportation industry and the government agencies charged with monitoring shipments. This lack of an acceptable solution is due to many factors which complicate interstate and international shipping. Shipping containers are used to transport most of the commerce entering, leaving, and transiting or moving within the United States. It is estimated that there are over 6 million containers moving in global commerce. Shipping containers have revolutionized the transportation of goods by greatly reducing the number of times goods must be loaded and unloaded during transport. However, at the same time, this same advantage has created a major problem in that it is very difficult to monitor and track the contents of each container during transport.

Beyond their basic construction, monitoring the content of shipping containers is also difficult because these containers are carried through numerous transit points and depots all over the world and it is impractical to stop and check the contents of each container individually at each point of transit. Dealing with this problem, the U.S. Customs Service estimates it can inspect just 5% of the 6 million containers entering and reentering the U.S. each year. Accordingly, agencies such as the United States Customs Service are seeking improved ways to achieve cargo container security and integrity upon arrival at the ports of entry of the United States.

To date, many government agencies have initiated programs to improve container security. These include many useful elements that are intended to preclude their use by terrorists. However, at present, none of the container tracking systems in use provides a way to assure the integrity of the contents of the containers to assure global container security. Current computer tracking systems are effective at monitoring the location of individual containers from point of origin to destination and maintaining an inventory of loaded and empty containers.

A successful container tracking system must be able to monitor the location, contents or bill of lading, and the data from any number of sensors to detect tampering or compromise of any given container. In order to accomplish this, each container in the system may be equipped with an apparatus to collect, analyze, and communicate this data to a central collection and processing location. Because these container systems are often in remote areas, difficult to locate, and not easily serviced or maintained, the communication systems used for tracking require power sources which allow them to operate over months or years without maintenance or replacement of batteries. Current approaches utilize large and sometime expensive battery packs or integrated batteries, but due to the power required to operate sensor systems and satellite/wireless transmitters, the operating life of the system may be less than desired.

For this reason, it is very desirable to have a system which can be powered using non conventional sources such as solar power. In this case the container's batteries could be periodically recharged and a more efficient power management algorithm may be utilized. There are several different photovoltaic technologies suitable for the container monitoring application. Standard photovoltaic crystalline cells and panels typically used for solar power have good efficiency, but are relatively expensive as compared to a lower efficiency thin film photovoltaic process. However, both technologies have their merits and may be considered.

### DESCRIPTION OF THE RELATED ART

A container security system as described by System Planning Corporation (SPC) (U.S. Pat. No. 7,098,784) herein referred to as “the SPC Invention”, performs many of the functions to monitor containers, their content, and to detect tampering within a container during transit. This is accomplished through a device is which located on a container, which performs multiple functions. Some of these functions may include controlling various sensors, collecting the data from these sensors and transmitting this data back to a central monitoring station. The central monitoring station may also send commands and information to individual containers equipment with this device.

To enable information to be transmitted to and from the container, there are several communications subsystems including a satellite or cellular communications device, or both. This system also describes the utilization of a global positioning element, and short range wireless or local area communication channel to communicate with various sensors and other elements within the container.

In the SPC invention, the power for all of these devices is provided through a conventional battery pack. Depending on the number of transmissions per day and on the functions performed by the container monitoring system, this pack may last for several months or for a few years. Once the batteries are depleted, the container may again be moved and the system may not be aware of the location anymore. This situation further complicates the maintenance and servicing of these containers, and they may not be monitored for some period of time until maintenance occurs, or even lost completely.

### SUMMARY OF THE INVENTION

To address the problem and limitations noted above, a system which can provide a self sufficient rechargeable power system is provided.

The preferred embodiments of this invention describe a battery pack module which comprises one or more battery cells, a recharge unit which comprises circuits to recharge the battery pack module as it is depleted, a power controller to perform multiple monitoring control, and recharge functions, and a pre-manufactured photovoltaic cell or the use of a photovoltaic spray film on top of a container as part of an integrated and concealed power supply for the monitoring and tracking electronics inside of a container. In the case of the pre-manufactured cell, the cells may be integrated into the roof or other locations of the container. In one preferred embodiment of the present invention, they may fit into the grooves of recessed portion of the corrugated areas of the container roof or walls, as to avoid damage during the handling of the containers. Over the past few years, advancements in photovoltaic cell manufacture have rendered these devices suitable for lower cost applications than they have been traditionally used for.

Another option for the photovoltaic areas is a thin film spray. The preferred embodiment of the present invention may use a spray coating which produces a film which may be applied to generate one or more solar cells.

Remaining battery capacity for each container may be monitored and reported to a central hub, such that only those minority containers that require battery replacement are tagged and serviced. With the recharge system in the present invention, many containers are recharged during transit or storage between transits and would not require service for long periods of time.

The process of depositing this material onto a surface is known as thin film technology. In the thin film photovoltaic application several material are used. Copper indium diselenide (CIS), after two decades of development, is becoming more prevalent, with modules reaching efficiencies from 11 to 19%. Thin film cells are produced by spraying a liquidized semiconductor material directly onto glass, plastic or stainless steel substrate. Semiconductor materials most frequently used in thin film technology are silicon, copper indium diselenide, or cadmium telluride. While thin film cells achieve lower efficiencies than the conventional crystalline cells, the production process is considerably less expensive, and because thin film cells can be extremely light and flexible.

In the container application, both the thin film and the crystalline cell technology have use and are proposed in the present invention as both technologies have benefits depending on the application.

### BRIEF DESCRIPTION OF THE DRAWINGS

FIG. 1 shows a functional configuration of the rechargeable power system for the container.

FIG. 2 shows a mechanical placement of the photovoltaic area into the roof of the cargo container.

FIG. 3 shows the preferred placement of crystalline photovoltaic cell panels.

FIG. 4 shows the construction of various layers for the photovoltaic thin film application.

### DESCRIPTION OF THE PREFERRED EMBODIMENTS

The present invention provides a unique system for providing a self sufficient and rechargeable power source for a cargo container monitoring and security system.

Throughout this specification, preferred embodiments of the invention are described in detail below with reference to the accompanying drawings. In the embodiments, various examples and illustrative embodiments are provided. It should be understood that these embodiments and examples are provided purely for purposes of illustration. The present invention is limited solely by the claims appended hereto.

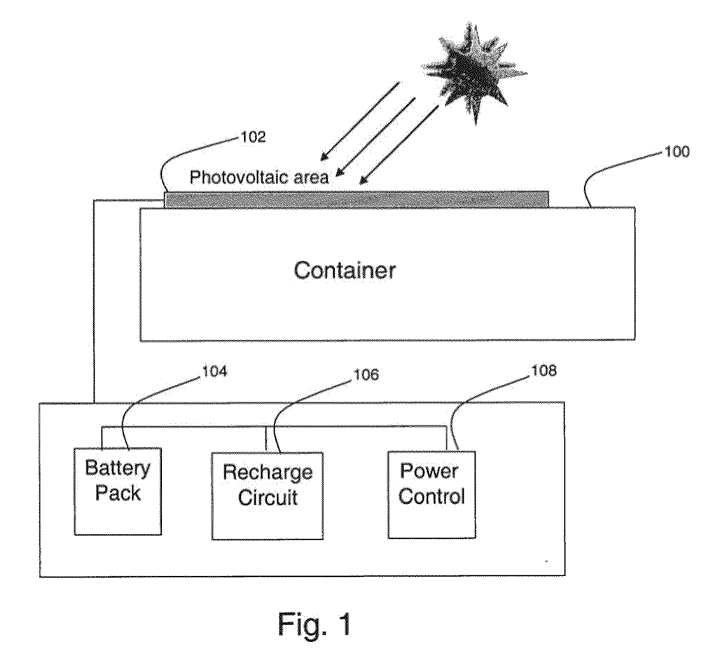

With reference now to FIG. 1, and for the purposes of explanation, the various components are shown which comprise an integrated rechargeable power system for providing long term power for the container electronics in a container monitoring system. In the preferred embodiments of the present invention, the various elements may include an integrated photovoltaic area 102 conforming to the container construction 100, a battery pack module which may include one or more rechargeable batteries or cells 104, a power conditioning circuitry or recharge unit 106, and a power controller unit 108. The photovoltaic area 102 will generate a voltage and current, which then may be provided to the power conditioning circuitry or recharge unit 106. The recharger unit 106 may allow voltage and current generated from said photovoltaic area 102 to recharge said battery element 104.

The power controller unit 108 may perform multiple functions which may include monitoring of remaining power of the system, controlling which elements of the system may be on and which ones may be off at specific times, and controlling the recharging times, rate, and limits of said battery pack module. The power controller element 108 may also notify a central monitoring station in the event that the photovoltaic area 102 may not be providing sufficient power to allow the recharging of said batteries in a timely manner such that the current date may be transmitted back to a central monitoring station and a maintenance call may be scheduled.

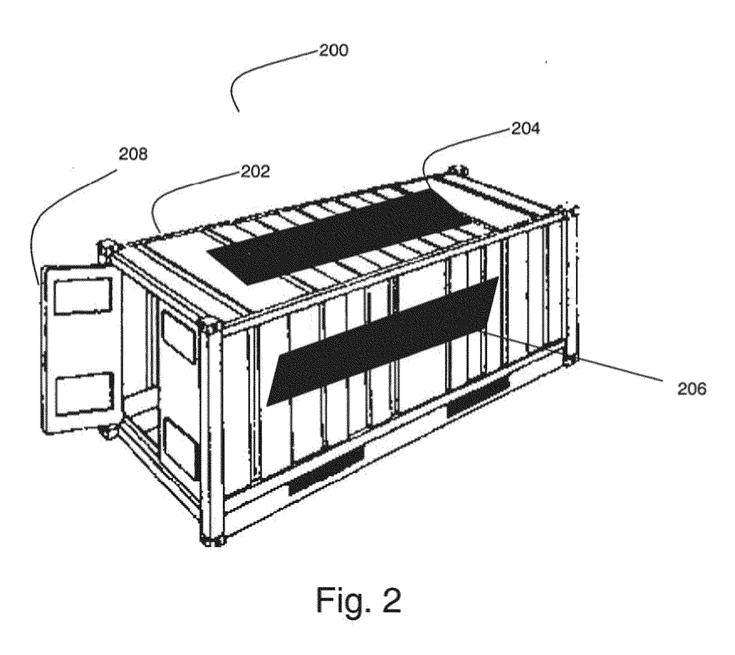

In the preferred embodiments of the present invention the photovoltaic area may be mechanically situation in multiple locations in the container. While the roof it is the most obvious area, because containers are stacked for long periods of time it may also make sense to have the photovoltaic areas on the door or walls. In the example provided in FIG. 2 of the present invention, a photovoltaic area on a container 202 is shown on a roof 204, walls 206, or on a door area 208. These areas may be small in size, or large enough to occupy the entirety of the container surfaces. As each of these areas may be suitable for different applications, the present invention may have photovoltaic situation in any combination or all of these areas.

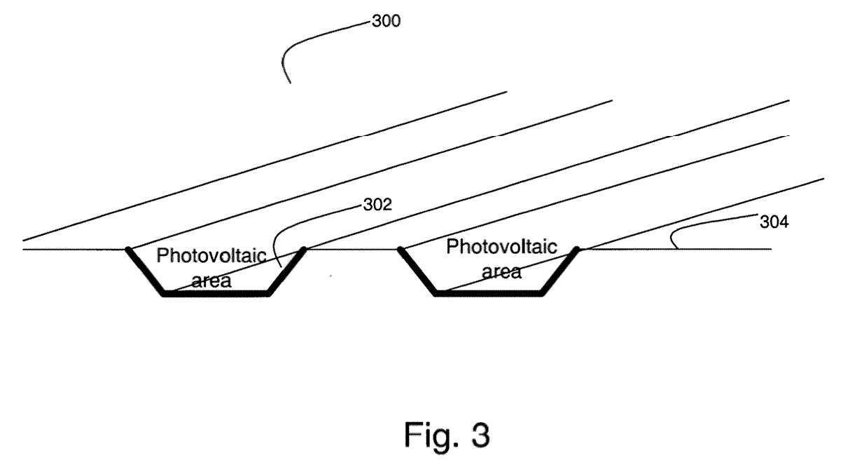

In the preferred embodiments of the present invention, there are two options for construction of the photovoltaic area. The first of these may be to have an area comprising pre-manufactured photovoltaic crystalline cell array strips that may be affixed only to the recessed corrugated horizontal, vertical, or angular portions of the container roof, walls, or door. In FIG. 3, these strips 302 are affixed in the container wall or roof cross section, but they are not present on the non-recessed areas 304, as they could easily be damage during the normal container handling and transport process. Multiple crystalline cell strips may be placed in the corrugated cavities and connected to create a large aggregate surface for the photovoltaic area. While almost all containers are constructed using steel or other hardened alloy material in corrugated form to superior strength, it may be possible for certain containers to have areas of a flat wall construction. For these applications the photovoltaic area may be simply affixed to a simple flat wall area in the same manner.

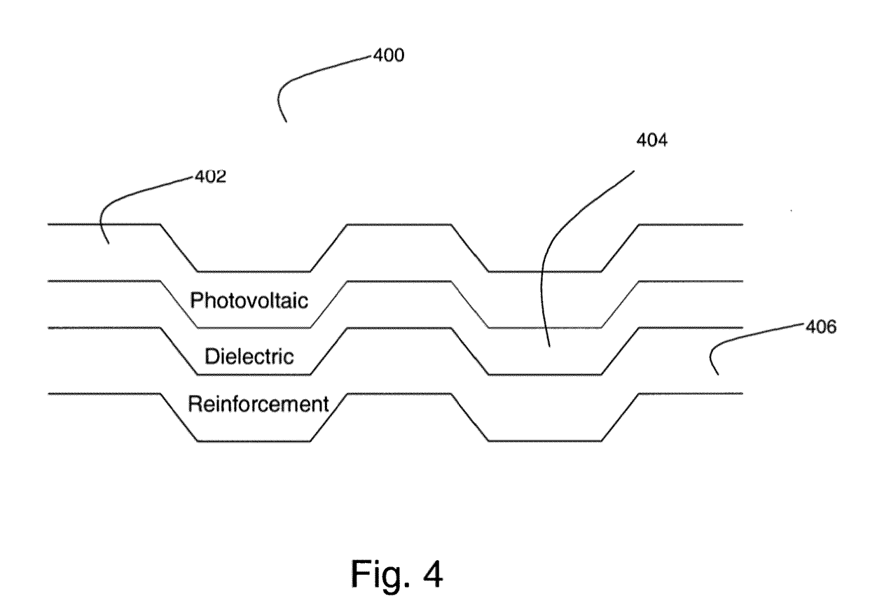

A second alternative for the photovoltaic area construction comprising an integrated photovoltaic material may applied to areas of the container roof, walls, or door using thin film application technology conforming to the container construction. The film may be applied in layers. In the example 400 in FIG. 4, a reinforcement layer 406 represents the wall or roof material of the container. Applied over this is an insulating or dielectric layer 404 which provides electrical isolation. A photovoltaic thin film layer 402 may be a spray coating of be a Copper Indium Diselenide or Cadmium Telluride photovoltaic or other material that has similar photovoltaic properties.

What is claimed is:

1. A method for providing an integrated rechargeable power system for providing long term power for monitoring a shipping container having horizontal, vertical, and/or angular elements which include raised surfaces and recessed surfaces, wherein the method comprises:
applying a dielectric layer directly onto a recessed surface of the shipping container;
spraying a liquidized photovoltaic element onto the surface of the dielectric layer;
providing a battery element; and
electrically connecting the photovoltaic element to the battery element for storing electrical energy.

2. The method of claim 1, wherein the photovoltaic element is comprised of a spray coating of a Copper Indium Diselenide.

3. The method of claim 1, wherein the photovoltaic element is comprised of a spray coating of a Cadmium Telluride.
